(19) United States
(12) Patent Application Publication
(10) Pub. No.: US 2025/0080610 A1
(43) Pub. Date: Mar. 6, 2025

(54) METHOD AND SYSTEM FOR AUTOMATICALLY ANNOTATING SENSOR DATA

(71) Applicant: dSPACE GmbH, Paderborn (DE)

(72) Inventors: Daniel ROEDLER, Karlsruhe (DE); Fabian BOTH, Karlsruhe (DE); Simon ROMANSKI, Karlsruhe (DE); Boris NEUBERT, Malsch (DE)

(21) Appl. No.: 18/728,472

(22) PCT Filed: Jan. 13, 2023
(86) PCT No.: PCT/EP2023/050717

§ 371 Date: Jul. 12, 2024

(30) Foreign Application Priority Data
Jan. 14, 2022 (DE) 10 2022 100 814.2

(51) Int. Cl. H04L 67/12; G06N 3/044; G06V 10/764; G06V 10/82; G06V 20/40; G10L 25/30

(52) U.S. Cl. CPC H04L 67/12; G06N 3/044; G06V 10/764; G06V 10/82; G06V 20/41; G10L 25/30

(57) ABSTRACT

A computer-implemented method for automatically annotating sensor data includes: receiving a multiplicity of sensor data frames; annotating the multiplicity of sensor data frames using at least one neural network, wherein the annotating comprises assigning at least one data point to each sensor data frame and assigning at least one state attribute to each data point; grouping the data points on the basis of the at least one state attribute, wherein a first group comprises data points for which the at least one state attribute is in a defined value range; selecting a first sample of one or more data points from the first group; and determining a quality metric for the one or more data points in the first sample.

### CROSS-REFERENCE TO PRIOR APPLICATIONS

This application is a U.S. National Phase application under 35 U.S.C. § 371 of International Application No. PCT/EP2023/050717, filed on Jan. 13, 2023, and claims benefit to German Patent Application No. DE 10 2022 100 814.2, filed on Jan. 14, 2023. The International Application was published in German on Jul. 20, 2023 as WO 2023/135244 A1 under PCT Article 21(2).

### FIELD

The present invention relates to methods and computer systems for automatically annotating sensor data frames, in particular data frames of an image-capturing sensor.

### BACKGROUND

Autonomous driving promises unprecedented levels of comfort and safety in everyday driving. Despite huge investments by various companies, however, the existing approaches are still only applicable under limited conditions and/or provide only a subset of genuinely autonomous behavior. One reason for this is the lack of a sufficient amount and variety of available driving scenarios. Further advances are thus prevented by the need for huge amounts of sufficiently distinct training data and validation data (i.e., independent ground truth data). In general, preparing training data requires many different travel scenarios to be recorded by a vehicle equipped with a set of sensors, in particular image-capturing sensors, such as one or more cameras, a LiDAR sensor, and/or a radar sensor. Before these recorded scenarios can be used as training data, they have to be annotated.

This is often done by annotation service providers, which receive the recorded sensor data and split them up into work packages for a multitude of human workers, who are also known as labelers. The precise annotations required (e.g., the distinct object categories) depend on each project and are set out in the detailed labeling specification. The customer delivers the raw data to the annotation service provider and expects high-quality annotations as per their specifications within a short timeframe. The number of labelers required to complete the annotation project increases as the volume of delivered data increases and also as the timeframe for a fixed data volume becomes shorter. For this reason, larger annotation projects that would, for example, deliver enough ground truth data to validate a self-driving vehicle are not feasible with humans alone; they require the annotation process to be automated.

Automation approaches use neural networks to label the recorded sensor data. An initial set of received data is manually labeled and then used to train neural networks. As soon as the neural networks are trained, they can annotate the huge volume of recorded image-capturing sensor data. Compared with a purely manual approach, this considerably reduces the work required. However, maintaining high annotation quality still requires time-consuming quality checks by humans. Since the quality assurance process still has to be applied for all annotations, there is a linear relationship between the project volume and the work needed to fulfill the project requirements.

Thus, improved methods for automatically annotating sensor data, in particular image-capturing sensor data, are needed; it would be particularly desirable to ensure high annotation quality with a reduced number of manual quality checks.

### SUMMARY

In an exemplary embodiment, the present invention provides a computer-implemented method for automatically annotating sensor data. The computer-implemented method includes: receiving a multiplicity of sensor data frames; annotating the multiplicity of sensor data frames using at least one neural network, wherein the annotating comprises assigning at least one data point to each sensor data frame and assigning at least one state attribute to each data point; grouping the data points on the basis of the at least one state attribute, wherein a first group comprises data points for which the at least one state attribute is in a defined value range; selecting a first sample of one or more data points from the first group; and determining a quality metric for the one or more data points in the first sample. Based on establishing that the quality metric of the first sample is below a predefined threshold, the method further includes: receiving corrected annotations for the data points in the first sample; retraining the at least one neural network on the basis of the one or more data points in the first sample; selecting a second sample of one or more data points of the first group that were not in the first sample; annotating sensor data frames of the second sample using the at least one retrained neural network; and determining a quality metric for the one or more data points in the second sample. Based on establishing that the quality metric of the second sample is above the predefined threshold, the method further includes: annotating remaining sensor data frames of the first group using the at least one retrained neural network; and exporting the sensor data frames of the first group that have been provided with annotations.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an example embodiment of a computer system,

FIG. 2 shows an example of a video frame having a schematic diagram of possible data points in the inset at the top left,

FIG. 3 is a schematic diagram of an automation system that carries out a method according to the invention,

FIG. 4 shows an example of data points that have been grouped in clusters having different quality grades,

FIG. 5a is a schematic diagram of a first step of sensor data frame batch processing,

FIG. 5b is a schematic diagram of a second step of sensor data frame batch processing,

FIG. 5c is a schematic diagram of a third step of sensor data frame batch processing,

FIG. 5d is a schematic diagram of a fourth step of sensor data frame batch processing, and

FIG. 5e is a schematic diagram of a fifth step of sensor data frame batch processing.

### DETAILED DESCRIPTION

Exemplary embodiments of the present invention provide methods and computer systems for automatically annotating sensor data frames, in particular video frames or LiDAR point clouds.

In a first aspect of the invention, a computer-implemented method for automatically annotating sensor data frames is provided; the method comprises the steps of receiving a multiplicity of sensor data frames, annotating the multiplicity of sensor data frames using at least one neural network, wherein annotation comprises assigning at least one data point to each sensor data frame and assigning at least one state attribute to each data point, grouping the data points on the basis of the at least one state attribute, wherein a first group comprises data points for which the at least one state attribute is in a defined value range, selecting a first sample of one or more data points from the first group, and determining a quality metric for the data points in the first sample. If the computer establishes that the quality metric of the first sample is below a predefined threshold, the method further comprises the steps of receiving corrected annotations for the data points in the first sample, retraining the neural network on the basis of the data points in the first sample, selecting a second sample of one or more data points of the first group that were not in the first sample, annotating the sensor data frames of the second sample using the retrained neural network, and determining a quality metric for the data points in the second sample. As soon as the computer establishes that the quality metric of the first or second sample is above a predefined threshold, the method further comprises annotating the remaining sensor data frames of the first group using the neural network, and exporting the sensor data frames of the first group that have been provided with annotations.

The computer system that carries out a method according to the invention can be implemented as an individual host computer that comprises a processor, e.g., a general-purpose microprocessor, a screen, and an input device. Alternatively, the computer system can also comprise one or more servers that have a multiplicity of processing elements such as processor cores or dedicated accelerators, the servers being connected via a network to a client comprising a screen and an input device. In this way, the annotation, or the automation software that comprises components for automatic annotation, can be executed in part or in full on a remote server, for example in a cloud computing environment, such that only a graphical user interface has to be implemented locally.

A data point can describe an object or a feature in a sensor data frame, in particular an image or a LiDAR point cloud, or indicate a property of the sensor data frame. Expediently, the checking of a data point is carried out on the sensor data frame that contains the object or feature associated with the data point or that has the property. A sensor data frame can comprise a plurality of data points, and a first data point in a sensor data frame can be checked independently of the examination of a second data point in the sensor data frame. For example, an object in a camera image can be annotated by data points in the form of a bounding box and an object category; depending on the category of the object, in particular a passenger car, this object can also be annotated with further attributes as data points, such as a blinker state. The number of assigned data points can depend on the content of the sensor data frame, such that an empty sensor data frame to which no data point is assigned can also occur. This empty sensor data frame would then be disregarded during further processing. Disregarding empty sensor data frames in this way is to be incorporated in the assignment of at least one data point to each sensor data frame.

A state attribute can describe the environmental conditions or, more generally, the prevailing circumstances when an object or feature assigned to the data point was recorded. The state attribute can be a static state attribute that in particular describes the environmental conditions at the time of recording. An environmental condition during recording of the frame can have a different impact on the accuracy of the annotations depending on the type of data point. Generally, in the case of annotations that comprise a plurality of data points, the impact of a state attribute can be different depending on the data point or type of data point. If, for example, the sensor data comprise camera images captured at night, the position and/or category of an object may be more difficult to determine. However, an attribute of a car, for instance the state of a blinker, may in some circumstances be more easily perceived at night than in full daylight. The state attribute can also be a dynamic state attribute ascertained in the course of the annotation via a neural network; it can even be an independent data point. One or more of the state attributes of one type of data point can be state attributes of a different type of data point. Moreover, a far-away object, for example, may be more difficult to recognize under the same environmental conditions, thus making classification difficult and limiting the accuracy of a bounding box. The size of the first object has no impact on the quality of the annotation of a second object (although any obscuration of the second object certainly does).

By grouping data points on the basis of at least one state attribute, possible correlations between state attributes and the accuracy of the annotation can be taken into consideration. The data points can be grouped independently of one another for different kinds or types of data points. The state attributes can have different effects from one data point type to another data point type, such that the individual data points of a particular type are preferably grouped together whereas different data point types are preferably grouped according to different criteria. The invention allows static and dynamic state attributes with adverse effects on the annotation quality to be identified, and allows the neural network to be improved under these conditions through selective retraining. In addition, it is possible to reduce the manual work required for corrections and quality checks.

The term “neural network” can relate to a single neural network, to a combination of different neural networks according to a predetermined architecture, or to any type of machine-learning-based technology that learns from training data in a supervised, semi-supervised, or unsupervised manner. Different neural networks can be used for different data points; the position and/or classification of the object can be determined using a first neural network while attributes of the object can be determined using at least one further neural network.

The present invention is based on the consideration that the quality of the various components of an annotation is systematically different in many cases. For example, an annotation may include a two-dimensional bounding box, an object category, and other attributes, for example a blinker status. While the quality for the object category, for example, is OK, the position of the bounding box may have to be corrected. A single data point thus constitutes the smallest unit of an annotation, the quality of which can be ascertained independently of other components of the annotation. Here, it is expedient to distinguish between different types of data points: a bounding box describes fundamentally different properties of an object than, for example, an attribute like the blinker status. As a result, a state attribute can have different effects on the quality of different types of data points, and some state attributes can have no impact on one type of data point but be critical for other types of data points. Breaking down a complex annotation into individual data points allows the impact of state attributes on the quality of annotations to be determined with fine granularity and also to be taken into consideration during correction.

The steps of selecting a second sample of one or more data points from the first group that were not in the first sample, and annotating the sensor data frame of the second sample using the retrained neural network can be switched around. For example, an entire batch of sensor data frames can be annotated using the retrained network before a second sample is selected.

This reduces the computing load particularly when the neural network has to be retrained multiple times, since in each case only the data points of the second or further sample have to be annotated using the retrained network. For the bulk of the sensor data frames, annotation can be deferred until it is established during the sample check that the retrained network delivers annotations of sufficient quality.

Exporting the annotated frames can include, for example, storing the frames on an external data medium and/or converting or merging them into a predetermined data format. Owing to the fine granularity of the data points, it would in principle also be possible to hand over partly annotated sensor data frames. For reasons of clarity, it may be advantageous to hand sensor data frames over to customers only when an adequately retrained neural network is available for all occurring types of data points, and thus only when the sensor data frames can be annotated in full.

Because manual work is used at least in the most part only to create training data, test data, and/or validation data for systematically improving the neural network or another machine-learning-based automation component for annotating the sensor data frames, the work required for large annotation projects can be considerably reduced. Typically, the quality level for delivering automation results, i.e., annotations by the neural network, is sufficient after a few iterations of neural network retraining, without any need for further manual checks. These, however, can continue to be carried out with a preferably small sample size independent of the data volume. A method according to the invention further reduces the required manual work and time by focusing the retraining on those conditions in which annotation quality is still lacking.

By way of example, an overlap between an automatically created bounding box and a bounding box that was created or adapted manually in the course of quality control can be used as a quality metric. Moreover, a maximum number and/or a maximum proportion of incorrectly assigned object categories and/or false positives and/or false negatives can be required. In that case, for example, the quality metric would be below the predefined threshold if the overlap of the bounding boxes is too low. As a quality metric, it can also be specified that a predetermined maximum number of false positives (incorrectly recognized objects) and/or false negatives (incorrectly unrecognized objects) may occur in one sample out of a predetermined number of frames. In that case, for example, the quality metric would be below the predefined threshold if the maximum permitted number of unrecognized objects were exceeded in the sample. When determining the quality metric, combined conditions can also be used, for example by merging individual values in a weighted manner.

If the computer establishes that the quality metric of the second sample is below a predefined threshold, the method preferably comprises the further steps of receiving corrected annotations for the data points in the sample currently being checked, retraining the neural network on the basis of the data points in the sample currently being checked, selecting a further sample of one or more data points of the first group that were not part of a previous sample, annotating the sensor data frames of the further sample using the neural network, and determining a quality metric for the data points of the further sample. Expediently, the further steps are repeated until the computer establishes that the quality metric for the frames in the further sample is above the predefined threshold or there are no remaining sensor data frames with uncorrected data points for the sample. As soon as the quality metric for the sensor data frames of a sample is above the predefined threshold, the method further comprises the steps of annotating the remaining sensor data frames of the first group using the neural network, which has then been sufficiently retrained, and exporting the annotated sensor data frames of the first group. This procedure allows the neural network to be quickly improved using a limited number of iterations.

Preferably, the step of receiving a multiplicity of sensor data frames comprises a step of preprocessing the sensor data frames, at least one state attribute being determined by a dedicated neural network on the basis of the frame, and/or at least one of the state attributes being determined on the basis of additional sensor data that were recorded at the same time as the sensor data frame. In particular, a dedicated neural network should be construed as a neural network trained specifically for the problem in question. The additional sensor data can be combined and/or used for queries to various services that indicate, for example, the weather conditions and a type of light conditions based on the time and geographical location.

In one embodiment, the sensor data frames are image data frames, i.e., they comprise data from an imaging sensor, such as one or more cameras, a LiDAR sensor, and/or a radar sensor. The received sensor data can also comprise additional sensor data that were recorded at the same time as the image data frames, such as a GPS position, an acceleration of the vehicle, or data from a rain sensor. For image data frames, the state attribute is preferably a geographical location, a time of day, a weather condition, a visibility condition, a type of road, a distance from an object and/or a traffic density, a size of a bounding box, an extent of obscuration and/or truncation, an ego vehicle speed, a camera parameter, a color range and/or a contrast metric of a region enclosed by a bounding box, a direction of travel of the ego vehicle, or comprises astronomical information such as the position of the sun relative to the direction of travel of the ego vehicle. The distance from an object can be a distance from the nearest object, a distance from the furthest-away object, or an average distance from a multiplicity of objects recognized in the frame; taking the distance to an object into consideration as an environmental condition when recording allows the impact on the object acquisition capacity and/or classification capacity of a neural network to be quantified. For image data frames, the at least one data point preferably comprises a position of an object, a category of an object, coordinates of a bounding box, coordinates of a line, a truncation of an object, an obscuration of an object, a correlation of an object in the image data frame with an object in a preceding or subsequent image data frame (as a result of the object being tracked), and/or an activation of a light indicator, such as a blinker or a brake light. The number of data points can depend on the content of the image data frame, for example large numbers of cars and pedestrians in a city scene with a corresponding number of object positions, object classifications, and possible attributes for the corresponding object category. For pedestrians, for example, their clothes, posture, and/or the direction in which they are looking could be additional attributes or data points.

In one embodiment, the received sensor data frames are audio frames, i.e., they comprise data from an audio sensor such as a microphone. For audio frames, the state attribute is preferably a geographical location, a gender and/or age of a speaker, a space size, and/or a background noise metric. For audio frames, the at least one data point comprises a phoneme and/or one or more words of a text recognized from the audio frame. Words can be recognized from a multiplicity of successive audio frames, so one data point can be derived from a multiplicity of audio frames. The difficulty in recognizing speech can, for example, depend on the frequency range produced by a speaker, on the occurrence of reverberations or echoes from the space, and/or on a level of background noise.

Preferably, grouping of the multiplicity of data points comprises determining clusters in a multi-dimensional space, in particular by using a nearest-neighbor algorithm and/or an unsupervised learning approach and/or a machine learning classification model. Preferably, the machine learning classification model assigns data points of one type to exactly one of at least two clusters which have different expected quality levels. Assignment to a cluster can be done by classification or grouping in a multi-dimensional space defined by a number of state attributes. The individual data points can thus be assigned to different clusters on the basis of the combined static and dynamic state attributes. However, it can also be envisaged to use all or a predetermined set of state attributes as context for the data points, so as to determine which state attributes have a notable impact on the quality of the data points of this type.

In one embodiment, annotation of the sensor data frames comprises assigning at least one data point of a first type and at least one data point of a second type to the individual sensor data frames. Particularly preferably, data points of the first type are grouped on the basis of the determination of clusters in a first multi-dimensional space, and data points of the second type are grouped on the basis of the determination of clusters in a second multi-dimensional space, the multi-dimensional space for one data point being defined by a number of state attributes. The state attribute here can be one that is assigned to the type of data point, but it may also be envisaged to use all or a predetermined set of state attributes as context for the data points and to ascertain, on the basis of the determination of clusters, which state attributes have a notable impact on the quality of the data points of this type.

Preferably, the first group is defined on the basis of a first cluster for which the at least one state attribute is in a first defined value range, and a second group is defined on the basis of a second defined value range, the first value range and the second value range for at least one state attribute and/or for all the state attributes assigned to each data point being disjoint. In principle, division into a larger number of clusters can also take place.

Preferably, the error probability, and thus the quality grade of a cluster, is established on the basis of the data points of a cluster by sampling. For example, a first data point could be assigned to a first cluster, and a second data point could be assigned to a second cluster. In this example, by using a sample, the quality grade of the first cluster would be ascertained at one hundred percent and that of the second cluster at zero percent (or the corresponding inverse error probabilities). Using statistical methods, the sample size can be dynamically adapted during measurement, and quality predictions from earlier measurements of the same cluster can be introduced. The aim here is to raise the quality grades of the various clusters above a desired threshold using minimal manual examination and correction work by iteratively improving the automated labeling. Preferably, more samples are taken and more data points are corrected for retraining for a cluster having a higher error probability or lower quality.

Particularly preferably, an error probability is determined for each data point on the basis of whether the data point is in the first or the second group. The quality grade is thus predicted: The individual data points can thus be given different quality grades on the basis of the combined static and dynamic state attributes. Preferably, more samples are taken for data points in the group having the higher error probability or lower quality.

If annotation of sensor data frames having a first type of data point is carried out on the basis of a first neural network, and annotation of sensor data frames having a second type of data point is carried out on the basis of a second neural network, the further method steps for the data points of the first type and the further method steps for the data points of the second type are expediently carried out independently of one another. Ascertaining quality levels, or a statistical quality analysis, can produce different error distributions for different data types. As a result of the independent processing, error correction and retraining are carried out in a targeted manner for each type of data point and can each be restricted to the specifically required scope.

Preferably, the selection of frames for the first sample depends on the data points for which the quality metric is to be determined, in particular a random selection of individual frames for object detection and/or a random selection of batches of successive frames for object tracking. Applying a smart strategy to sampling maximizes the improvement obtainable by retraining. An object detector, for example for recognizing road signs, benefits from training data with high variance, and so a random selection of individual frames is a useful first sample. On the other hand, a tracking component benefits from continuous data since only then can the same object be tracked between successive frames. Expediently in this case, a series of successive frames, for example always ten, would be randomly selected as a sample for a variety of objects. As an example, smart sampling would take frames 10 to 20 and frames 100 to 110 and 235 to 245 for the first sample when determining a quality metric for a tracking component. To obtain high variance in the sample, the software component carrying out the sampling can stipulate a minimum time interval between samples so as to ensure that different frames have been captured under different environmental conditions. Additionally or alternatively, one or more attributes can be taken into consideration in the sampling. If, for example, a sample is selected for quantifying the capabilities of the object detector at night, various environments such as city, countryside, or freeway can be stipulated. The random selection would then be made among all the samples that satisfy the stipulated criterion.

Preferably, annotation of sensor data and recording of sensor data are carried out alternately or simultaneously, and if it is ascertained that the quality metric for at least one frame in the first sample is below a predefined threshold, the computer requests the recording of additional sensor data for which the at least one condition attribute is in the selected value range of the first packet. A value range of the condition attribute can be selected by fitting a test vehicle with an automated recording apparatus that executes a selection program which triggers recording as soon as a predefined recording condition is satisfied, or by requesting that a test driver drive under certain conditions, e.g., at night. New data are thus recorded at least primarily for the environmental conditions for which the neural network requires further training. Carefully selecting training data maximizes the improvement obtained per unit training time. Thus, the computing time required for the training is reduced, and so too is the energy consumption.

In one embodiment, receiving corrected annotations for a data point comprises receiving a multiplicity of provisional annotations and ascertaining a corrected annotation on the basis of the multiplicity of provisional annotations, in particular a selection on the basis of either an average or a majority decision. For data points of the bounding box type, the averages of a plurality of values for the coordinates and/or the size of the bounding box can be calculated. For other types, a majority decision may be more suitable. Therefore, to attain higher annotation quality, provisional annotations or partial annotations can be created by multiple labelers and used as the basis for ascertaining the ground truth. This is particularly advantageous for annotations of the first batches of sensor data frames since it also allows the labeling specification to be checked.

One aspect of the invention also relates to a non-volatile computer-readable medium containing instructions which, when executed by a microprocessor of a computer system, cause the computer system to carry out a method according to the invention as described above or in the appended claims.

A further aspect of the invention provides a computer system comprising a host computer that comprises a processor, a main memory, a display, a device for human input, and a non-volatile memory, in particular a hard disk or a solid-state drive. The non-volatile memory contains instructions which, when executed by the processor, cause the computer system to carry out a method according to the invention.

The processor can be a multi-purpose microprocessor that is conventionally used as the CPU of a personal computer, or it can comprise one or a multiplicity of processing elements configured to execute special calculations, such as a graphics processor. In alternative embodiments of the invention, the processor can be replaced or supplemented by a programmable logic device, such as an FPGA, which is configured to provide a set range of functions, and/or it can comprise an IP core microprocessor.

The invention will be described in more detail below with reference to the drawings. Like parts are denoted by identical reference numerals. The illustrated embodiments are highly schematic, i.e., the distances and the lateral and vertical dimensions are not true to scale and, unless indicated otherwise, do not have any derivable geometric relationships to each other either.

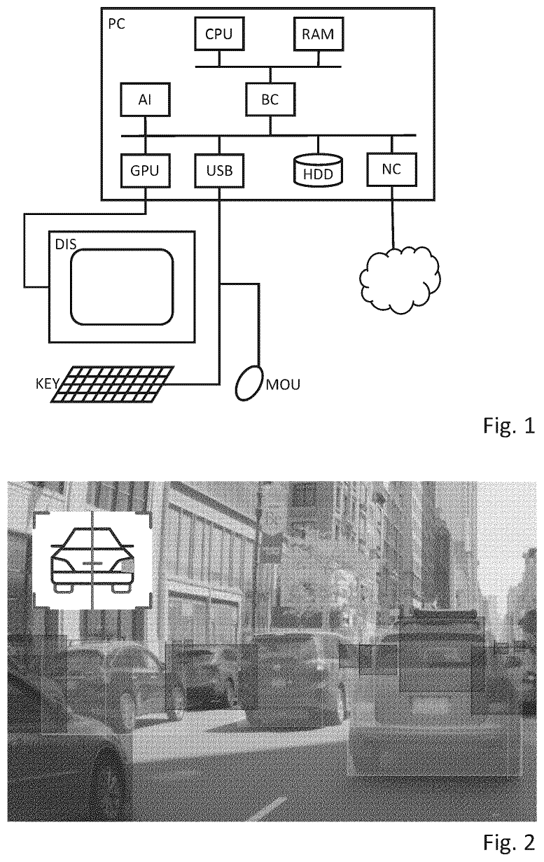

FIG. 1 shows an example embodiment of a computer system.

The embodiment shown comprises a host computer PC having a display DIS and user interface devices such as a keyboard KEY and a mouse MOU; furthermore, an external server can be connected via a network, as indicated by a cloud symbol.

The host computer PC comprises at least one processor CPU having one or more cores, a main memory RAM, and a number of devices that are connected to a local bus (such as PCI Express) which exchanges data with the CPU via a bus controller BC. The devices include, for example, a graphics processor GPU for activating the display, a controller USB for connecting peripherals, a non-volatile memory HDD, such as a hard disk or a solid-state disk, and a network interface NC. Moreover, the host computer can comprise a dedicated accelerator AI for neural networks. The accelerator AI can be configured as a programmable logic module, such as an FPGA, as a graphics processor suitable for general calculations, or as an application-specific integrated circuit. Preferably, the non-volatile memory contains instructions which, when executed by one or more cores of the processor CPU, cause the computer system to carry out a method according to the invention.

In alternative embodiments (indicated as a cloud in the figure), the computer system can comprise one or more servers, which comprise one or more processing elements, the server being connected via a network to a client such as the host computer PC. Thus, the annotation environment can be executed in part or in full on a remote server, such as in cloud computing equipment. Mobile terminals can also be used as the client as an alternative to a host computer; for instance, a graphical user interface of the annotation environment can be executed in particular on a smartphone or a tablet having a touchscreen user interface.

FIG. 2 shows a camera image as an example sensor data frame having a schematic diagram of possible data points in the inset at the top left.

The city scene photograph shown in the figure can be an individual image or part of a video recording. Generally, a recording provided by a customer may include video or audio data representing a successive context, for example a five-minute drive, recorded using imaging sensors such as a camera and a LiDAR sensor, or a ten-minute speech recording. Video recordings may, for example, include a series of successive frames, which in turn contain a series of objects. The recording is processed at least via a neural network in order to create annotations. Annotations can comprise a multiplicity of data points, with each data point describing one specific aspect.

A data point is a parameter describing a particular property of a recording and can be applied to all levels of detail. Levels of detail can be the entire recording, a series of successive or random frames, a single frame, or an object in a frame. A specific example would be an annotation for a car, including a bounding box, which describes the position of the car to within a certain degree of accuracy, a vertical line, which marks an edge of the car, a classification for describing the type of car, and attributes for truncation or obscuration, blinkers, brake lights, colors, etc. Data points can be categories, boxes, segments, polygons, polylines, attributes such as blinkers, brake lights, colors, subcategories, tracking information, degree of obscuration, degree of truncation, complex categories describing the relevance of an object/frame/clip, sound, text, or any other information that can be ascertained in an automated manner.

The inset at the top left in the figure shows various data points for a car. Cars can be of different types, for example a delivery truck, an SUV, or a sports car. The position, or rather the dimensions, of a car are generally indicated by a bounding box, i.e., a rectangular frame or cuboid encompassing the car. Vertical lines indicate the boundaries of the car. A further possible data point for a car is the activation of a light indicator, for instance the directional indicator or blinker shown in the inset.

The frame contains a multiplicity of cars, each enclosed by a bounding box. Cars may be fully visible, like the one driving directly in front of the camera, or they may be obscured. The traffic density in the city scene can compromise annotation quality by making it difficult, for example, to precisely determine the limits of the bounding box owing to obscuration.

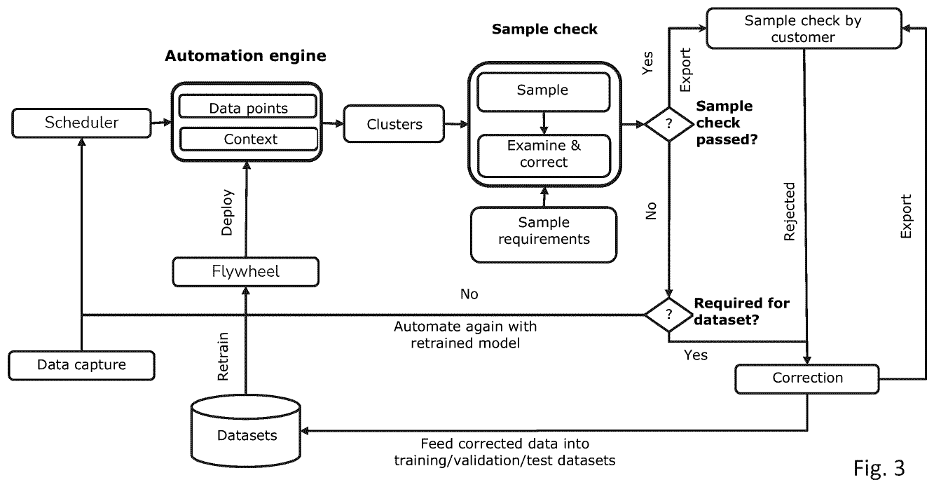

FIG. 3 is a schematic diagram of an automation system that carries out a method according to the invention. The automation system implements various steps of the method in dedicated components and is well suited for execution in a cloud computing environment.

In a first step, “Data capture”, unsorted recordings are received from a customer. The recordings can be standardized, for example split into sensor data frames or images, to enable consistent processing. This step can also comprise an enrichment phase, in which the sensor data frames of the recordings are automatically enriched with metadata that are relevant for measuring automation quality. For example, each image can be assigned the geographical location at which it was captured, in particular on the basis of the GPS coordinates that were received at the same time as the images. In the context of autonomous driving, metadata or state attributes that are relevant to annotation quality could include a weather condition, a type of road, a light condition, and/or a time of day. These state attributes indicate conditions while a sensor data frame was being captured and can also be described as static. Other state attributes, for example the size of a bounding box, which can also have an impact on labeling quality, for example in object recognition (large objects are easier to recognize), only become apparent from a completed annotation and can therefore be described as dynamic.

For the efficiency of the automation, it is expedient to process batches of frames or individual images together in the following steps. In projects in which image capture and processing are interleaved, it may be advantageous to accrue frames captured under the same environmental conditions until a predetermined batch size is reached, before continuing with the further processing steps.

In a second step, “Scheduler”, different batches of sensor data frames or individual images are scheduled for annotation by an automation engine. In this case, the scheduler can select one or more automation components to annotate the frames with one or more data points for execution by the automation engine. Furthermore, the scheduler can select the frame batch to be processed on the basis of the availability of new versions of automation components. An automation component can generate a single data point, such as a vertical line, or a plurality of contiguous data points, such as the coordinates of a bounding box, and an object category. The automation components can be neural networks or another machine-learning-based technology that learns from data samples in a supervised, semi-supervised or unsupervised manner.

In a third step, “Automation engine”, a batch of sensor data frames is processed by at least one automation component which assigns data points to the frames. The automation system generates any type of data point using automation components, which are thus a central part of the workflow of the automation system. Preferably, the data points are provided with metadata that precisely describe the version of the automation component used. The automation engine comprises techniques for precisely storing relevant metadata using automation components, for example a specific database. Some of the state attributes associated with a data point can be determined by a dedicated automation component. The context, i.e., the state attribute for a data point, can comprise attributes that are themselves a data point. For example, the accuracy of the placement of a vertical line can depend on the size of the bounding box in which the line is to be drawn.

In a fourth step, “Clustering”, the individual data points of a particular type are grouped on the basis of state attributes. It may be envisaged to assign certain state attributes to one type of data point. The state attributes for a bounding box can, for example, include the size of the bounding box, the time of day and/or the weather conditions when the image was captured and/or partial obscuration of the object. The values of the state attributes of the individual bounding boxes can form a plurality of clusters in the multi-dimensional space defined by the state attributes. Different clusters can be associated with a different annotation quality.

Listing 1

| Data | | |
|---|---|---|
| point | B01 Position | B02 Position |
| Context | Type: 2dbb | Type: 2dbb |
| | Category: truck | Category: truck |
| | Dimensions: 143 px × 265 px | Dimensions: 155 px × 95 px |
| | Vertical line: 10 px | Vertical line: not available |
| | Relevant: true | Relevant: false |
| | Obscuration: 0% | Obscuration: 10% |
| | Pose: back left | Pose: front right |
| | Lens effect: severe lens flare | Lens effect: severe lens flare |
| | Reflections: light | Reflections: light |
| | Weather condition: wet | Weather condition: wet |
| | Sky: cloudy | Sky: cloudy |
| | Time of day: night | Time of day: night |
| | Scenario: freeway | Scenario: freeway |
| | Traffic: low | Traffic: low |
| | Ego speed: 112 km/h | Ego speed: 112 km/h |
| | Ego direction: 263° | Ego direction: 263° |
| | GPS: at Karlsruhe | GPS: at Karlsruhe |
| | Angle of view: 90° | Angle of view: 90° |

Listing 1 above shows an example context comprising a plurality of state attributes for two example data points: a bounding box B01 and a bounding box B02, which each indicate the position of an object. The individual state attributes describe conditions that may affect the quality of annotation.

On the basis of a multiplicity of individual data points of the same type, the automation system can thus determine clusters in a multi-dimensional space, in particular by using a nearest-neighbor algorithm and/or an unsupervised learning approach and/or a machine learning classification model. The ascertained clusters can be analyzed in order to specify a criterion for grouping data points and/or predicting annotation quality, by defining value ranges for at least one of the state attributes of the data point.

Preferably, grouping is carried out on the basis of defined value ranges for a plurality of state attributes. Grouping can be done, for example, on the basis of the dimensions of the bounding box; objects that are close to the camera or are large can allow the bounding box to be placed accurately. By contrast, the relative error in the placement of a bounding box around a small, far-away object may be considerable. Therefore, large dimensions correlate with a higher quality of the bounding boxes. The weather is a further condition attribute that can be used for grouping the data points, for example due to the lower contrast and/or the distortion in the image caused by water droplets on the camera lens. Other condition attributes may have no significant impact on quality fluctuations of the data points and can be disregarded; for example, the field of vision or angle of view of a camera used for capturing the images may be constant for all the images captured by that camera. Grouping on the basis of value ranges can also be done using a neural network or a machine learning classification model.

In a fifth step, “Sample check”, quality control is carried out for a sample of data points. In a first phase, “Sample”, a plurality of data points are selected for quality control on the basis of sample requirements. The frequency and/or size of the samples taken for a group of data points can be selected on the basis of the predicted quality of the data points in the group; for data points associated with state attributes that suggest poor quality, samples can be taken more frequently. In a second phase, “Examine & correct”, a human annotator can be shown the frame having corresponding annotations, for example a bounding box, and they can be asked whether the bounding box is correct. Alternatively, the annotator can be shown a user interface for finely adjusting the bounding box and/or adding a bounding box in the event of “false negatives”, in order to annotate an object overlooked by the neural network. The automation system determines a quality metric from the type and number of corrections made by the human annotator. Expediently, the quality metric is selected such that an overlooked object is weighted more heavily than a bounding box whose placement had to be refined.

In a sixth step, “Sample check passed?”, the system determines whether the quality metric of the sample was above a predefined threshold (which indicates adequate annotation quality). If the automation system establishes that this is the case (Yes), the group of individual images comprising the selected sample can be exported and handed over to the customer. If this is not the case (No), execution continues with a seventh step.

In the seventh step, “Required for dataset?”, it is ascertained whether the manually corrected sample is intended to be used for retraining the automation component for the data point. Whether this is the case may depend on how many images have been captured under the same conditions that have already been used for training the model. If this is not the case (No), the group of data points from which the sample was taken is sent back to the scheduler (Automate again with retrained model). As soon as a retrained automation component for the data points is available, the scheduler sends the group of data points to the automation engine for reprocessing. If the corrected samples are intended to be used for retraining (Yes), the manually annotated data points are fed into the training/validation/test datasets for the relevant neural network/automation component. These datasets are represented by a cylinder.

In an eighth step, “Flywheel”, the neural network or automation component that generated the data points rejected during the sample check is retrained. As the neural network learns more, the quality of the automation is improved. Preferably, the automation components are improved to such an extent that no more manual checks are required for as many clusters as possible. The iteration periods for retraining should be as short as possible to allow the efficiency to be improved quickly.

The flywheel step comprises techniques for efficient storage and versioning of training datasets for any automation component or any type of data point, for monitoring changes to the training datasets, and for automatically triggering retraining as soon as predefined or automatically ascertained thresholds for changes to the training datasets are exceeded (e.g., a predetermined number of new examples). In addition, the flywheel step comprises techniques for automatically deploying retrained neural networks in automation components and for informing the scheduler of version changes.

If new data frames are captured at the same time as or alternately with the annotation of the data frames, an additional step of targeted data acquisition can be carried out. The automation components are improved by a large number of training iterations on a dataset that is constantly refined and depicts the variance in the real world more and more effectively over time. At least for static state attributes, a systematic approach can be followed on the basis of confidence levels or error probabilities for each cluster, in order to collect data frames for situations in which the automation results are the weakest. For example, the automatic annotation of sensor data frames captured at night can lead to unacceptable annotation quality. As soon as this is established during the sample check, the targeted capture of data at night can be requested in order to improve the training dataset of the automation component under those environmental conditions. In particular, the quantity of additional training datasets under the relevant problematic environmental conditions can be determined on the basis of the confidence or the error probability ascertained for the corresponding clusters. All the data recorded under the same conditions can be used for retraining. As soon as the incorrectly annotated sensor data frames have been corrected, they are fed directly into the training dataset of the corresponding automation component. Generally, however, not all the data have to be manually corrected for a particular cluster and data point. Instead, only samples up to the next threshold for retraining have to be collected and corrected. The rest of the data are automatically scheduled for a new run with a newer version of the automation component. Targeted data collection comprises techniques for selecting samples of interest on the basis of clusters up to predefined quantities for manual correction. In addition, it preferably comprises techniques for labeling poor-quality samples that are not needed for retraining for automation runs on newer versions of the relevant automation component.

If the automatic annotations of the sample examined in the sixth step are of adequate quality, the annotations can be handed over to the customer. In a ninth step, “Sample check by customer”, the customer can check a sample of the exported sensor data frames to ensure that the annotations meet their specifications and satisfy the required annotation quality. If the customer rejects the group of frames, a sample or the entire group of frames is manually processed in a tenth step “Correction”. The ninth and tenth steps are optional and can therefore be omitted.

In the tenth step, “Correction”, a sample or the entire group of sensor data frames rejected by the customer is manually annotated. Optionally, the manually annotated frames can be exported to be checked again by the customer. The manually annotated frames are preferably used for retraining the neural network by the corrected data being fed into the training/validation/test datasets.

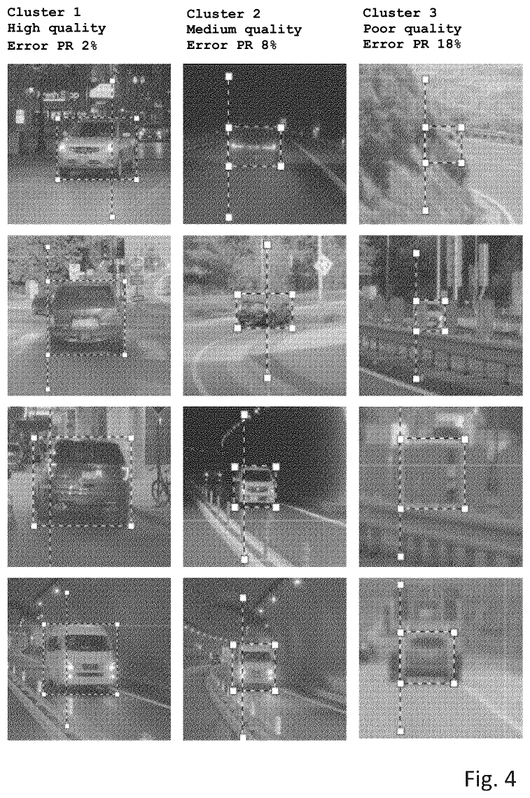

FIG. 4 shows an example of data points that have been grouped in clusters having different quality grades.

The figure shows details of sensor data frames captured using a camera, each showing a vehicle. A bounding box encompassing the outline of the vehicle has been drawn around each vehicle. Additionally, the vehicles have been annotated with a vertical line, each of which indicates an edge of the vehicle and thus allows conclusions to be drawn about the relative angle between the vehicle and the camera. Thus, data points of two different types are shown, the bounding box illustrating a primary data type that may be present independently in an image or sensor data frame. By contrast, a vertical line is shown only when vehicles are recognized and therefore represents a secondary data point.

The relative accuracy of the bounding boxes depends on the size of the enclosed object, for example, because large objects are easier to recognize than small or far-away objects. The size of the bounding box, however, also has a significant impact on the accuracy of the vertical line. Other influencing factors on the quality of the annotation with vertical lines can be, for example, the light conditions and a degree of obscuration, which can thus represent relevant state attributes.

The image details shown or vehicles recognized are clustered in three groups for which different error probabilities have been predicted or ascertained. The left-hand column shows examples of cluster 1, which comprises high-quality data points (or vertical lines) in which an error probability (Error PR) is 2%. The middle column shows examples of cluster 2, which comprises medium-quality data points in which an error probability (Error PR) is 8%. The right-hand column shows examples of cluster 3, which comprises low-quality data points in which an error probability (Error PR) is 18%.

Clustering allows value ranges to be ascertained for the relevant state attributes, for example that a degree of obscuration of more than 30% correlates with poor annotation quality. The shape of a cluster can be complex, in particular when there are large numbers of relevant state attributes; expediently, any such clusters can be described by trained neural networks or a machine learning classification model.

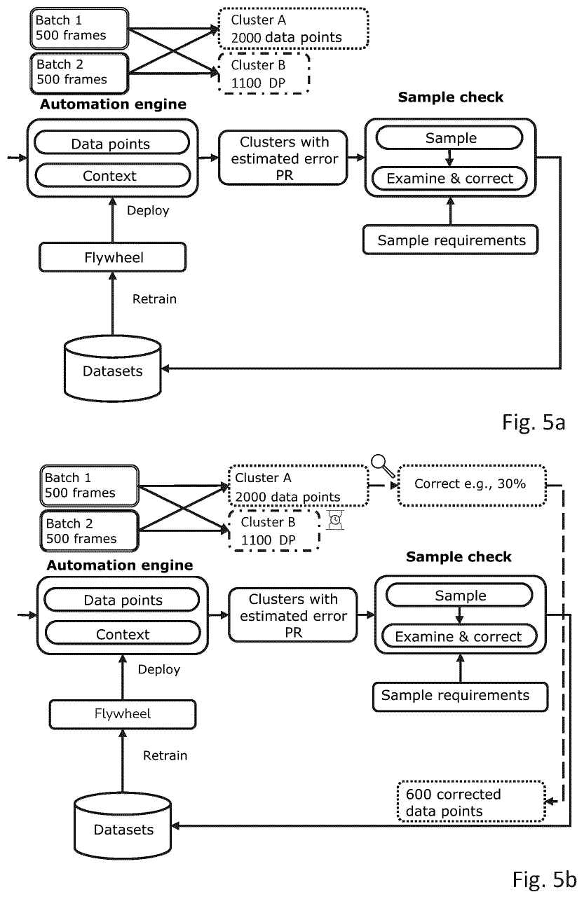

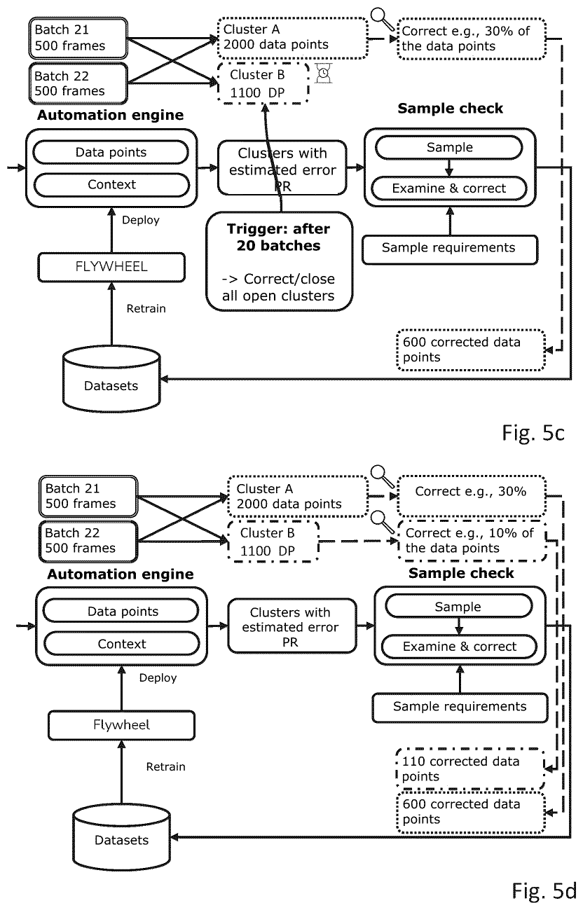

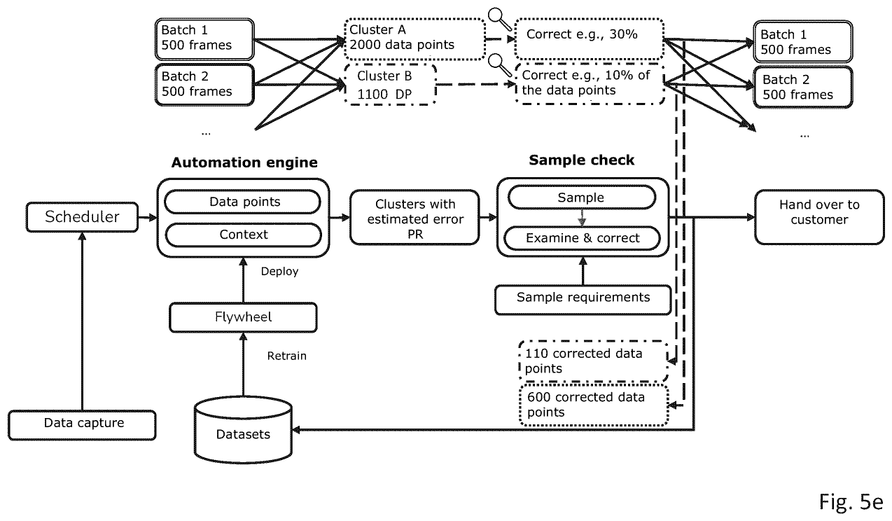

FIG. 5a is a schematic diagram of a first step of sensor data frame batch processing. The processing can be carried out in an automation system like that shown in FIG. 3; the steps that are not shown can be carried out as part of the batch processing.

Splitting up complex annotations into individual data points allows the state attributes that are relevant to the quality metric to be observed with fine granularity. In addition, the required computing time is also reduced as it is necessary to observe only the data points for which a retrained neural network is available, for example, whereas other data points of the sensor data frames can be retained. In the present case, the general handling of data points is explained on the basis of a simplified example that contains only one type of data point (e.g., bounding boxes around objects) and two clusters (cluster A: poor quality, cluster B: good quality) for this type of data point.

The sensor data frames received as input data, e.g., camera images, are split into fixed-size batches to enable consistent processing by the automation engine. The figure shows two batches, each of 500 frames of sensor data. The automation engine executes an object recognition neural network, which provides objects in a frame with bounding boxes. Once the batches have been annotated, and the individual data points have also been assigned a context from various state attributes, the data points are grouped in cluster A (dotted border) comprising poor-quality data points, and cluster B (dash-dot border) comprising good-quality data points. By way of example, three data points in cluster A and two data points in cluster B can result from a single camera image or frame. In the example shown, cluster A comprises 2000 data points and cluster B 1100 data points (DP).

FIG. 5b is a schematic diagram of a second step of sensor data frame batch processing.

As soon as the clusters have reached a particular size and/or a predetermined time period has elapsed, the sample is checked. On the basis of predefined sample requirements, some data points are taken as a sample. A manual examination and correction step is now carried out (the other steps can be carried out fully automatically by a computer), and the automation system receives corrected data points for the sample. For the sake of simplicity, the entire cluster is taken as a sample in the present case.

In the example shown, cluster A has reached the size threshold for a sample check (indicated by a magnifying glass) whereas cluster B is initially not checked (indicated by an hourglass). By way of example, it was found that 30% of the data points in cluster A had to be corrected (“Correct e.g., 30%”) to reach the desired quality level. In the present case, it is assumed for simplicity that all the data points of a corrected sample are used for retraining the neural network. Thus, 600 corrected data points are available to be incorporated into the training datasets.

FIG. 5c is a schematic diagram of a third step of sensor data frame batch processing.

The example shows that further batches of sensor data frames or camera images have been received as input data, with batches 21 and 22 currently being processed. Although the size of cluster B has not changed in the example shown, a trigger condition for the sample check on cluster B has been met: a predetermined number of batches (20) has been processed, so a sample is now to be taken from all previously unchecked clusters and checked or corrected (“Correct/close all open clusters”).

FIG. 5d is a schematic diagram of a fourth step of sensor data frame batch processing.

The result of the sample check of cluster B (indicated by an hourglass) was that 10% of the data points of the cluster had to be corrected (“Correct e.g., 10% of data points”) to reach the desired quality level. Since in the present case all the data points of a corrected sample are used for retraining the neural network, 110 corrected data points are in turn available to be incorporated into the training datasets. In batch processing, there is additionally the option to train using either all the annotated sensor data frames of the corrected batch or only the corrected data points.

FIG. 5e is a schematic diagram of a fifth and final step of sensor data frame batch processing. As in FIG. 3, a module for data capture and a scheduler are shown in this case too.

Batch 1 and batch 2 are shown; a multiplicity of further batches is indicated by ellipses. Once the data points of the batches have been divided into cluster A and cluster B and the samples have been checked and corrected, the neural network is retrained. As soon as the desired quality level has been reached in further samples, the batches can be handed over to the customer with assurances about the statistical quality (“Handover to customer”). In this case, significant proportions of the annotated sensor data frames can be handed over without needing any manual reworking.

The above-described method can also be used for sensor data frames from a LiDAR sensor, i.e., point clouds, or for multi-sensor set-ups. In this case, independent grouping and correction are carried out for the various types of data points. Since only the samples required for training are manually corrected, a large proportion of the input data can be automatically annotated as soon as the retrained neural network is available for the particular type of data point.

By using the correlation between the quality of annotations and state attributes, the method according to the invention allows manual work to be targeted at rapidly improving neural networks, which can then be used for creating automatic annotations to be handed over to customers. By processing different types of data points separately and re-annotating only when there is a retrained neural network available, for example, particularly effective use is made of computing time. Overall, larger annotation projects required for validation purposes, for example, are sped up considerably.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A computer-implemented method for automatically annotating sensor data, wherein the method comprises:
receiving a multiplicity of sensor data frames;
annotating the multiplicity of sensor data frames using at least one neural network, wherein the annotating comprises assigning at least one data point to each sensor data frame and assigning at least one state attribute to each data point;
grouping the data points on the basis of the at least one state attribute, wherein a first group comprises data points for which the at least one state attribute is in a defined value range;
selecting a first sample of one or more data points from the first group, and determining a quality metric for the one or more data points in the first sample;
wherein, based on establishing that the quality metric of the first sample is below a predefined threshold, the method further comprises:
receiving corrected annotations for the data points in the first sample;
retraining the at least one neural network on the basis of the one or more data points in the first sample;
selecting a second sample of one or more data points of the first group that were not in the first sample;
annotating sensor data frames of the second sample using the at least one retrained neural network; and
determining a quality metric for the one or more data points in the second sample;
wherein, based on establishing that the quality metric of the second sample is above the predefined threshold, the method further comprises:
annotating remaining sensor data frames of the first group using the at least one retrained neural network; and
exporting the sensor data frames of the first group that have been provided with annotations.

2: A computer-implemented method for automatically annotating sensor data, wherein the method comprises:
receiving a multiplicity of sensor data frames;
annotating the multiplicity of sensor data frames using at least one neural network, wherein the annotating comprises assigning at least one data point to each sensor data frame and assigning at least one state attribute to each data point,
grouping the data points on the basis of the at least one state attribute, wherein a first group comprises data points for which the at least one state attribute is in a defined value range;
selecting a first sample of one or more data points from the first group, and determining a quality metric for the one or more data points in the first sample;
wherein, based on establishing that the quality metric of the first sample is below a predefined threshold, the method further comprises:
receiving corrected annotations for the data points in the first sample;
retraining the at least one neural network on the basis of the one or more data points in the first sample;
selecting a second sample of one or more data points of the first group that were not in the first sample;
annotating sensor data frames of the second sample using the at least one retrained neural network; and
determining a quality metric for the one or more data points in the second sample;
wherein, based on establishing that the quality metric of the second sample is below the predefined threshold, the method further comprises the following steps being repeated until a respective quality metric for respective frames in a respective further sample is above the predefined threshold or there are no remaining sensor data frames with uncorrected data points to sample:
receiving corrected annotations for data points in a sample currently being checked;
retraining the neural network on the basis of the data points in the sample currently being checked;
selecting a further sample of one or more data points of the first group that were not part of a previous sample;
annotating sensor data frames of the further sample using the retrained neural network; and
determining a quality metric for the one or more data points of the further sample.

3: The computer-implemented method according to claim 1, wherein at least one respective state attribute is determined by a dedicated neural network on the basis of:
the sensor data frames; and/or
additional sensor data recorded at the same time as the sensor data.

4: The computer-implemented method according to claim 1, wherein the sensor data frames are image data frames;
wherein the at least one state attribute comprises a geographical location, a time of day, a weather condition, a visibility condition, a type of road, a distance from an object and/or a traffic density, a size of a bounding box, an extent of obscuration and/or truncation, an ego vehicle speed, a camera parameter, a color range and/or a contrast metric of a region enclosed by a bounding box, a direction of travel of the ego vehicle, astronomical information; and/or
wherein the at least one data point comprises a position of an object, a category of an object, coordinates of a bounding box, coordinates of a line, a truncation of an object, an obscuration of an object, a correlation of an object in the image data frame with an object in a preceding or subsequent image data frame, and/or an activation of a light indicator.

5: The computer-implemented method according to claim 1, wherein the sensor data frames are audio frames;
wherein the at least one state attribute comprises a geographical location, a gender and/or age of a speaker, a space size and/or a background noise metric; and/or
wherein the at least one data point comprises a phoneme and/or one or more words recognized from the audio frame.

6: The computer-implemented method according to claim 1, wherein grouping the data points comprises:
determining clusters in a multi-dimensional space by using a nearest-neighbor algorithm, an unsupervised learning approach, and/or a machine learning classification model.

7: The computer-implemented method according to claim 6, wherein the annotating comprises:
assigning at least one data point of a first type and at least one data point of a second type to individual sensor data frames, wherein data points of the first type are grouped in a first multi-dimensional space on the basis of the determination of clusters, and data points of the second type are grouped in a second multi-dimensional space on the basis of the determination of clusters, wherein a respective multi-dimensional space for a respective data point is defined by a number of state attributes.

8: The computer-implemented method according to claim 6, wherein the first group is defined on the basis of a first cluster for which the at least one state attribute is in a first defined value range, and a second group is defined on the basis of a second defined value range, wherein the first value range and the second value range for at least one state attribute assigned to each data point are disjoint.

9: The computer-implemented method according to claim 8, wherein an error probability is determined for each data point on the basis of whether the data point is in the first or the second group, and wherein more samples are taken for data points in the group having the higher error probability.

10: The computer-implemented method according to claim 1, wherein annotation of sensor data frames having a first type of data point is carried out on the basis of a first neural network, and annotation of sensor data frames having a second type of data point is carried out on the basis of a second neural network.

11: The computer-implemented method according to claim 1, wherein selecting the first sample is dependent on a random selection of individual images for data points related to object recognition and/or a random selection of stacks of successive frames for data points related to object tracking.

12: The computer-implemented method according to claim 1, wherein annotation of sensor data frames and receipt of sensor data frames are carried out alternately or simultaneously, and wherein, based on establishing that the quality metric for a sample is below a predefined threshold, the transmission of sensor data frames in which the at least one state attribute is in the defined value range is requested.

13: The computer-implemented method according to claim 1, wherein receiving corrected annotations for a data point comprises receiving a multiplicity of provisional annotations and ascertaining a corrected annotation on the basis of the multiplicity of provisional annotations.

14: A non-transitory computer-readable medium having processor-executable instructions stored thereon, wherein the processor-executable instructions, when executed, facilitate performance of the method according to claim 1 by a computing system.

15: A computing system, comprising:
a host computer, wherein the host computer comprises a processor, a main memory, a display, an input device, and a non-volatile memory;
wherein the non-volatile memory comprises instructions which, when executed by the processor, facilitates performance of the following by the computing system;
receiving a multiplicity of sensor data frames;
annotating the multiplicity of sensor data frames using at least one neural network, wherein the annotating comprises assigning at least one data point to each sensor data frame and assigning at least one state attribute to each data point,
grouping the data points on the basis of the at least one state attribute, wherein a first group comprises data points for which the at least one state attribute is in a defined value range;
selecting a first sample of one or more data points from the first group, and determining a quality metric for the one or more data points in the first sample;
wherein, based on establishing that the quality metric of the first sample is below a predefined threshold, the method further comprises:
receiving corrected annotations for the data points in the first sample;
retraining the at least one neural network on the basis of the one or more data points in the first sample;
selecting a second sample of one or more data points of the first group that were not in the first sample;
annotating sensor data frames of the second sample using the at least one retrained neural network; and
determining a quality metric for the one or more data points in the second sample;
wherein, based on establishing that the quality metric of the second sample is above the predefined threshold, the method further comprises:
annotating remaining sensor data frames of the first group using the at least one retrained neural network; and
exporting the sensor data frames of the first group that have been provided with annotations.
